(19) United States
(12) Patent Application Publication
(10) Pub. No.: US 2026/0109456 A1
(43) Pub. Date: Apr. 23, 2026

(54) CONTROL SYSTEM AND METHOD FOR AN AIRCRAFT

(71) Applicant: Airbus Operations Limited, FILTON (GB)

(72) Inventors: Florian BECHER, FILTON (GB); Rima URAIQAT, FILTON (GB)

(21) Appl. No.: 19/306,215

(22) Filed: Aug. 21, 2025

(30) Foreign Application Priority Data
Oct. 18, 2024 (GB) 2415357.9

(51) Int. Cl. B64C 25/46; B64C 25/42; B64D 45/08

(52) U.S. Cl. CPC B64C 25/46; B64C 25/426; B64D 45/08

(57) ABSTRACT

An aircraft including a control system configured to receive: an indication of the deceleration of the aircraft during landing, an indication of a target deceleration level for the aircraft, and an indication of factors that might prevent the aircraft from meeting that target deceleration level. The control system is configured to output a command to indicate to the pilot that the target deceleration level of the aircraft is not being met. The control system is configured to indicate whether this was caused by one of the brake systems of the aircraft being skid-limited or whether the aircraft is achieving maximum available braking and is still not able to meet the target deceleration level. The control system may be retrofitted by the installation of software on an existing aircraft. A method for determining and indicating scenarios that limit the aircraft's ability to decelerate during landing.

### CROSS-REFERENCES TO RELATED APPLICATIONS

This application claims the benefit of United Kingdom Patent Application Number 2415357.9 filed on Oct. 18, 2024, the entire disclosure of which is incorporated herein by way of reference.

### FIELD OF THE INVENTION

The present disclosure relates to a control system for an aircraft, for use during landing, and a related method. The disclosure also concerns an aircraft comprising such a control system. The disclosure also concerns a method of converting an existing aircraft into an aircraft comprising such a control system.

### BACKGROUND OF THE INVENTION

The present disclosure has particular application to commercial passenger aircraft but may have application in relation to other types of aircraft such as cargo aircraft.

There is a desire to reduce the number of pilots needed to safely fly an aircraft or alternatively to improve aircraft safety. Having only a single pilot in the cockpit of an aircraft, brings with it the desire to decrease pilot workload. In order to improve safety and reduce pilot workload, it is desirable to provide systems that can automate, at least partially, various functions of the aircraft and to determine and communicate to the pilot various information in a manner that assists the pilot during various phases of operation. One such phase of operation is deceleration of the aircraft during landing.

Autobrake systems (for example as disclosed in US2008149436A1) that allow the brake system of the aircraft to be controlled by an automated system during landing are known. Known autobrake systems include those where a pre-determined deceleration requirement is set by the pilot and the autobrake system works to automatically decelerate the aircraft at the selected level. Brake to vacate (BTV) autobrake systems instead allow the pilot to determine which runway exit they would prefer to use, and then the autobrake system works to automatically decelerate the aircraft at a rate that will allow that exit to be used. Such a brake to vacate system has been implemented on certain commercially available aircraft such as the Airbus A350 and A380 aircraft.

There are therefore known systems on an aircraft that assist flight crew in controlling the aircraft on the ground. There still exist opportunities to improve the way in which such systems improve automation of aircraft maneuvers and reduce the need for flight crew intervention with aircraft systems that are used in controlling aircraft maneuvers. There are various scenarios that may reduce or limit the aircraft's ability to meet a target deceleration level during landing. It is important to reduce the pilot's workload during these scenarios, particularly for example during single pilot operations. It is also desirable that an aircraft be configured for both single pilot flight and multiple pilot flight.

The present invention seeks to mitigate one or more of the above-mentioned problems. Alternatively or additionally, the present invention seeks to provide an improved control system and method for determining and indicating scenarios that limit the aircraft's ability to decelerate during landing.

### SUMMARY OF THE INVENTION

The present invention provides, according to a first aspect, a control system for an aircraft. The aircraft has a brake system that is configured to issue a command for a target deceleration level during landing. The brake system may also be configured to limit the braking of the aircraft in the event of skid conditions being detected. The brake system may be configured to use wheel brakes, reverse thrusters, ground spoilers, and/or airbrakes in order to decelerate the aircraft. The brake system may be configured to limit the amount of pressure applied by wheel brakes in the event of skid conditions being detected. The control system may be configured to receive, for example as a first input, an indication from the brake system regarding whether the aircraft's ability to brake is limited (for example by an anti-skid function operating). The control system may be configured to receive, for example as a second input, an indication from the brake system regarding whether the aircraft (or a braking function of the aircraft) is achieving maximum available braking (for example, all wheel brakes at full braking pressure). In an example scenario, the brake system achieves maximum available braking of the aircraft by using a combination of ground spoilers, wheel brakes and reverse thrusters to decelerate the aircraft. The control system is configured to receive, for example as a third input, an indication of the deceleration of the aircraft. The control system is configured to receive, for example as a fourth input, an indication of the target deceleration level from the brake system. The control system is configured to generate an output in dependence on at least some of the first to fourth inputs that, in use, causes the generation of an indication alerting the pilot to the deceleration of the aircraft being below the target deceleration level, and preferably also a reason why the deceleration of the aircraft cannot be increased. For example, the control system may be configured to use the first, third and fourth inputs to determine that the deceleration of the aircraft is below the target deceleration level but that the aircraft's ability to brake is limited (a first scenario, for example in which an anti-skid function is operating which prevents wheels brakes from braking harder). The control system may be configured to use the second, third and fourth inputs to determine that the deceleration of the aircraft is below the target deceleration level but that the aircraft is achieving maximum available braking (a second scenario). For either scenario, the control unit is preferably configured to generate a corresponding output for causing an indication that alerts the pilot to the relevant scenario so determined by the control unit.

The control system may be configured to generate, for example as a first output, a command to indicate to the pilot that deceleration of the aircraft is below the target deceleration level but that the aircraft's ability to brake is limited. The control system may be configured to generate, for example as a second output, a command to indicate to the pilot that deceleration of the aircraft is below the target deceleration level but that the aircraft is achieving maximum available braking.

In embodiments, the provision of a control system that is able to inform the pilot of the reason why the deceleration of the aircraft cannot be increased despite deceleration being below the target deceleration level, allows the workload of the pilot to be reduced and increases the safety of the aircraft as there is a reduced likelihood of the pilot mistakenly overriding any skid limitations placed on the aircraft braking by an autobrake system.

The first input may include one or more inputs in combination. The second input may include one or more inputs in combination. The third input may include one or more inputs in combination. The fourth input may include one or more inputs in combination.

The control system may be configured to determine whether the deceleration of the aircraft is equal to the target deceleration level. The control system may be configured to generate, for example as a third output, a command to indicate to the pilot whether the deceleration of the aircraft is equal to a target deceleration level.

The control system may be configured to receive the indication of the deceleration of the aircraft from one or more accelerometers located on the aircraft. The control system may be configured to receive the indication of the deceleration of the aircraft from the accelerometer(s), via other systems or devices on the aircraft. For example, the output of the accelerometer(s) may be processed and/or combined with other signals or data before being received by the control system.

The target deceleration level may be variable. The target deceleration level may vary throughout at least part of the landing phase of the aircraft while on the ground (for example being at two or more different levels, possibly five or more levels, and optionally constantly varying, for at least some of the time between touchdown of all wheels and when the aircraft has reached taxiing speed). The target deceleration level may be constant for at least some of the landing of the aircraft while on the ground (for example for at least 25% of the distance—or the time—between touchdown of all wheels and when the aircraft has reached taxiing speed).

The brake system of the aircraft may include a pedal brake. The control system may be configured to receive the indication of the target deceleration level from the pedal brake.

The brake system of the aircraft may include an autobrake system. The control system may be configured to receive the indication of the target deceleration level from the autobrake system.

In embodiments, the control system may be configured to receive an indication of the target deceleration level from the pedal brake and may also configured to receive an indication of the target deceleration level from an autobrake system. In embodiments, this allows the control system to function during use of the autobrake system and when the pilot manually overrides the autobrake system to manually set the target deceleration level using the pedal brake.

The brake system of the aircraft may be configured to periodically issue a command for the target deceleration level during landing. The control system may be configured to periodically receive an indication of the target deceleration level during landing. In embodiments, when the autobrake system of the aircraft is in a “brake-to-vacate” mode, the autobrake system is varying the target deceleration level throughout landing in order to allow the aircraft to exit a runway at a desired speed. In embodiments, the control system may be configured to periodically determine whether the deceleration of the aircraft is equal to the target deceleration level. The control system may be configured to periodically output a command to indicate to the pilot that deceleration of the aircraft is below the target deceleration level due to either the aircraft braking being limited or despite the aircraft achieving maximum available braking. The control system may be configured to periodically output a command to indicate to the pilot that deceleration of the aircraft is equal to the target deceleration level.

In certain embodiments it may be that at least part of the brake system and/or at least part of the control system is implemented in computing apparatus (e.g. computer hardware acting under instructions according to software installed on the hardware). It may be that at least a part of the brake system and at least a part of the control system is implemented in the same computing apparatus. It may be that one or more parts of the brake system and/or one or more parts of the control system are implemented in separate computing apparatus.

The indications to the pilot may comprise a visual indication, for example on a display unit in the cockpit of the aircraft. The indications to the pilot may comprise an audible indication, for example from a loudspeaker or other audio device in the cockpit of the aircraft.

The control system may be configured to output a command to a display unit, for example a primary flight display, to visually indicate to the pilot that deceleration of the aircraft is below the target deceleration level. Such a visual indication may be provided separately, or as part of the indication to the pilot of the first or second scenarios mentioned above. In embodiments, the control system being configured to output a command to visually indicate to the pilot that deceleration of the aircraft is below the target deceleration level increases the pilot's awareness of what the brake system of the aircraft is doing and decreases pilot workload.

The control system may be configured to output a command to a display unit, for example a primary flight display, or other hardware or instrument in the cockpit of the aircraft, to indicate to the pilot by audio alert that the deceleration of the aircraft is below the target deceleration level.

The control system may be configured to output a command to a display unit to indicate with a first indication that the aircraft's ability to brake is limited due to skid conditions when the aircraft is in a skid limited state (which may be an example of the first scenario). It may be that the first indication is only displayed when the aircraft is not able to achieve the target deceleration.

The control system may be configured to output a command to the display unit to indicate with a second indication, the second indication being different from the first indication, that the aircraft is achieving maximum available braking (which may be an example of the second scenario). It may be that the second indication is only displayed when the aircraft is not able to achieve the target deceleration.

In embodiments, the control system being configured to output a command to a display unit, for example a primary flight display to indicate with a first indication that the aircraft's ability to brake is limited due to skid conditions when the aircraft is in a skid limited state allows the pilot (and/or other flight crew) to understand why the deceleration of the aircraft is below the target deceleration level and reduces the pilot workload as it prevents them (the pilot and/or other flight crew) from considering that they might need to manually override an automated braking system (e.g. an autobrake system or “brake to vacate” system) of the aircraft in order to achieve the target deceleration level. (The control system and/or the brake system may be configured to allow a pilot to manually override automated operation.) In embodiments, the control system being configured to output a command to the display unit to indicate with a second indication that the aircraft is achieving maximum available braking, when the aircraft is achieving maximum available braking but is not able to achieve the target deceleration, allows the pilot to understand why the deceleration of the aircraft cannot be increased despite being below the target deceleration level and reduces the pilot workload as it prevents them from considering that the autobrake system may have some kind of fault and that they might need to override the autobrake system of the aircraft in order to achieve the target deceleration level.

The present invention provides, according to a second aspect, an aircraft including a control system in accordance with the first aspect of the invention. The aircraft may include a brake system. The brake system may be arranged to send to the control system the first input, that being the indication from the brake system regarding whether the aircraft's ability to brake is limited. The brake system may be arranged to send to the control system the second input, that being the indication from the brake system regarding whether the aircraft is achieving maximum available braking. The aircraft may include a display unit, for example a flight display, on which, for example, the indication alerting the pilot to the first scenario (deceleration of the aircraft being below the target deceleration level due to the aircraft braking being limited - e.g. due to skid conditions) is arranged to be displayed and on which, for example, the indication alerting the pilot to the second scenario (deceleration of the aircraft being below the target deceleration level despite the aircraft achieving maximum available braking - e.g. despite the wheel brakes being applied at the maximum level possible and the ground spoilers and reverse thrusters being deployed) is arranged to be displayed.

The brake system of the aircraft may be configured to determine whether the aircraft is experiencing skid conditions by analyzing inputs from sensors on the one or more wheels of landing gear of the aircraft. The brake system of the aircraft may be configured to determine whether the aircraft is experiencing skid conditions by analyzing the wheel rotation speed detected by sensors on one or more of the wheels of the aircraft landing gear. The brake system may be configured to limit the braking of the aircraft when it determines the presence of skid conditions. The brake system may be configured to limit the wheel braking of the aircraft when it determines the presence of skid conditions, whilst maintaining non-limited braking from the deployment of ground spoilers and reverse thrust.

The brake system of the aircraft may be configured to receive an indication of skid conditions on the runway prior to landing (for example from air traffic control).

The brake system of the aircraft may be configured to receive an indication of skid conditions from other systems onboard the aircraft.

The display unit may include a visual indicator to provide a visual indication to the pilot that deceleration of the aircraft is below the target deceleration level either due to the aircraft braking being limited due to skid conditions, or despite the aircraft achieving maximum available braking.

The display unit is preferably located in a cockpit of the aircraft. The display unit may comprise a flight display, for example a primary flight display. The display unit may comprise an airport navigation display. The display unit may be configured to display an air pressure indicator. The display unit may be configured to display a vertical speed indicator. The display unit may be configured to display a heading indicator. The display unit may be configured to display an aircraft nose attitude indicator. The display unit may be configured to display the current mode of the autobrake system. The display unit may be configured to display a radio altitude indicator. The display unit may be configured to display an altitude indicator. The display unit may be configured to display an airspeed indicator. The display unit may be configured to display a groundspeed indicator. The display unit may be configured to display an indicator of slat/flap positions. The display unit may be configured to display a landing gear position indicator. The display unit may be configured to display a pitch/trim indicator. The display unit may be configured to display a ground spoiler position indicator.

The aircraft may include an audio indicator to provide an audible indication to the pilot that deceleration of the aircraft is below the target deceleration level. An audio indicator may indicate to the pilot whether the aircraft deceleration is below the target deceleration level due to the aircraft braking being limited due to skid conditions. An audio indicator may indicate to the pilot whether the aircraft deceleration is below the target deceleration level despite the aircraft achieving maximum available braking.

The visual indication that the aircraft braking is limited due to skid conditions, may be different from the visual indication that the aircraft is achieving maximum available braking.

In embodiments, the visual indication that the aircraft braking is limited due to skid conditions being different from the visual indication that the aircraft is achieving maximum available braking provides the benefit of increasing the pilot's awareness of the reason why deceleration of the aircraft is not meeting the target deceleration level.

The brake system of the aircraft may be configured to automatically determine the target deceleration. For example, the brake system may be configured to operate in an autobrake function, by which the deceleration of the aircraft is automated, for example to reduce the speed of the aircraft after touchdown of the wheels to taxiing speed. The brake system may be configured to operate in a brake to vacate function, by which the deceleration of the aircraft is automated, for example to reduce the speed of the aircraft after touchdown of the wheels to an appropriate speed to exit the runway.

The brake system of the aircraft may include a pedal brake configured to be manually operable to allow the pilot to determine the target deceleration.

The present invention provides, according to a third aspect, a method of braking an aircraft during landing. The aircraft may include a control system, for example a control system according to the first aspect of the invention. The method comprises a step of the control system comparing a measured deceleration of the aircraft with a target deceleration level. The method may comprise the control system receiving an indication of the deceleration of the aircraft. The method may comprise the control system receiving an indication of a target deceleration level. The method comprises the control system outputting a command to a cockpit instrument, for example a display unit, to indicate to the pilot why the deceleration of the aircraft is below a target deceleration level, for example by imparting information regarding why the deceleration of the aircraft cannot be increased despite being below the target deceleration level. The method may for example comprise the control system outputting a command to the cockpit instrument that indicates, preferably separately, to the pilot that the deceleration of the aircraft is below a target deceleration level and additionally why the deceleration of the aircraft cannot be increased despite being below a target deceleration level.

The step of the control system comparing the deceleration of the aircraft with the target deceleration level may result in the control system determining whether the deceleration of the aircraft is below the target deceleration level.

The method may include the control system determining whether the deceleration of the aircraft is such that the target deceleration level is met, and if so, causing a cockpit instrument, for example a display unit, on the aircraft to indicate to the pilot that the deceleration of the aircraft is in accordance with the target deceleration level (i.e. that the target deceleration level is being met).

The method may further comprise the step of one or more accelerometer(s) outputting an indication of the deceleration of the aircraft to the control system.

The method may further comprise the step of a brake system of the aircraft outputting an indication of the target deceleration level to the control system.

The method may further comprise a cockpit instrument on the aircraft receiving the command from the control system to indicate to the pilot why the deceleration of the aircraft is below a target deceleration level. The method may further comprise the cockpit instrument providing an indication to the pilot as to why the deceleration of the aircraft cannot be increased despite being below a target deceleration level.

The method may further comprise the control system receiving an indication regarding whether the aircraft's ability to brake is limited due to skid conditions. The step of the control system outputting a command to indicate to the pilot why the deceleration of the aircraft cannot be increased despite being below a target deceleration level, may include outputting a command to indicate to the pilot that the aircraft's braking is limited due to skid conditions.

The method may further comprise the cockpit instrument receiving the command from the control system to indicate to the pilot that the aircraft's braking is limited due to skid conditions. The method may further comprise the cockpit instrument providing an indication to the pilot that the aircraft's braking is limited due to skid conditions.

The method may further comprise the control system receiving an indication regarding whether the aircraft is achieving maximum available braking. The step of the control system outputting a command to indicate to the pilot why the deceleration of the aircraft cannot be increased despite being below a target deceleration level, may include outputting a command to indicate to the pilot that the aircraft is achieving maximum available braking.

The method may further comprise the cockpit instrument receiving the command from the control system to indicate to the pilot that the aircraft is achieving maximum available braking. The method may further comprise the cockpit instrument providing an indication to the pilot that the aircraft is achieving maximum available braking.

The present invention provides, according to a fourth aspect, a computer program product. The computer program product comprises instructions which, when the program is executed by a system comprising a suitable computer or programmable control module, cause the system to be in accordance with the control system of the first aspect of the invention or cause the system to carry out one or more of the steps of the method of the third aspect of the invention.

When implemented, the computer program product may cause interaction between a brake system, a control system and a pilot indication system. The brake system, the control system and the pilot indication system may be at least in part implemented by one or more on-board computers. The control system may be configured to receive inputs from the brake system, and as a result to output signals that control, or influence indications provided to the pilot by the pilot indication system. The pilot indication system may comprise a cockpit instrument. The pilot indication system may comprise a display unit, for example a primary flight display and/or an airport navigation display.

The present invention provides, according to a fifth aspect, a method of modifying an existing aircraft. The aircraft may have a primary indication on a cockpit display for indicating whether the deceleration of the aircraft is equal to the target deceleration. The method comprises adapting the cockpit display to have a secondary indication, the secondary indication indicating the reason why deceleration of the aircraft cannot be increased despite deceleration being below the target deceleration level. The method further comprises installing a software on a system of the aircraft such that when installed the system of the aircraft is configured to: detect whether the deceleration of the aircraft is less than the target deceleration; detect whether this is due to the aircraft braking being skid limited or despite the aircraft achieving maximum available braking; and issue a command to the cockpit display to indicate to the pilot using the secondary indication, why deceleration of the aircraft cannot be increased despite deceleration being below the target deceleration level.

The present invention provides, according to a sixth aspect, a display apparatus for an aircraft. The display apparatus comprises a display unit for an aircraft cockpit, for example comprising a primary flight display, and a control system. The control system is configured to determine whether the deceleration of the aircraft is below a target deceleration level. The control system is configured to determine the reason for the deceleration of the aircraft being below the target deceleration level (for example why deceleration of the aircraft cannot be increased despite the deceleration being below the target deceleration level). The control system is configured to output a command to the display unit to indicate to the pilot with a first indication if the deceleration is below the target deceleration level due to the aircraft braking being limited due to skid conditions. The control system is configured to output a command to the display unit to indicate to the pilot with a second indication if the deceleration is below the target deceleration level despite the aircraft achieving maximum available braking.

The display unit may comprise a cockpit instrument. The display unit may comprise an airport navigation display. The display unit may comprise a primary flight display. The display unit may be a combination of two or more cockpit instruments, for example comprising both a primary flight display and an airport navigation display.

The aircraft of any of the aspects of the invention may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

It will of course be appreciated that features described in relation to one aspect of the present invention may be incorporated into other aspects of the present invention. For example, the method of the invention may incorporate any of the features described with reference to the apparatus of the invention and vice versa.

### BRIEF DESCRIPTION OF THE DRAWINGS

Embodiments of the present invention will now be described by way of example only with reference to the accompanying schematic drawings of which:

FIG. 1 shows a front view of an aircraft including a control system according to a first embodiment of the invention;

FIG. 2 schematically shows various systems of the aircraft including the control system according to the first embodiment of the invention;

FIG. 3 schematically shows various systems of the aircraft including the control system according to an alternative embodiment of the invention;

FIG. 4a shows a schematic diagram of a primary flight display according to the first embodiment of the invention;

FIG. 4b shows a schematic diagram of a portion of a primary flight display according to an alternative embodiment of the invention;

FIG. 5 is a flow diagram illustrating a method of using a control system according to an embodiment of the invention; and

FIG. 6 is a flow diagram illustrating a method of retrofitting an existing aircraft according to an embodiment of the invention.

### DETAILED DESCRIPTION OF THE PREFERRED EMBODIMENTS

Embodiments of the present invention relate to determining whether the deceleration of the aircraft is below a target deceleration level during landing, determining the reason why deceleration of the aircraft is lower than the target deceleration level and indicating the reason for the deceleration being lower than the target to the pilot of the aircraft. This provides the pilot with reduced workload during landing and reduces the likelihood of the pilot unnecessarily over-riding functionality of the brake system in order to try to manually achieve the target deceleration level. Embodiments of this invention will be described in relation to the accompanying drawings.

It will be appreciated that the landing phase of an aircraft starts when the aircraft is airborne and ready to land and ends when the aircraft's speed has reduced to taxiing speed. The present embodiment relates to the use of brake systems on the aircraft to reduce its speed whilst in a landing phase and on the ground (e.g. on the runway).

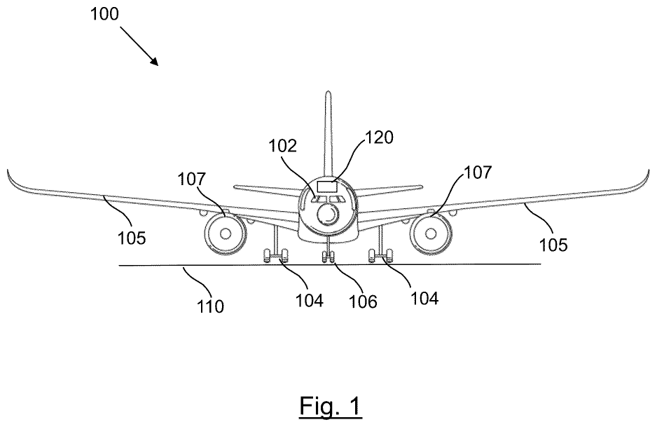

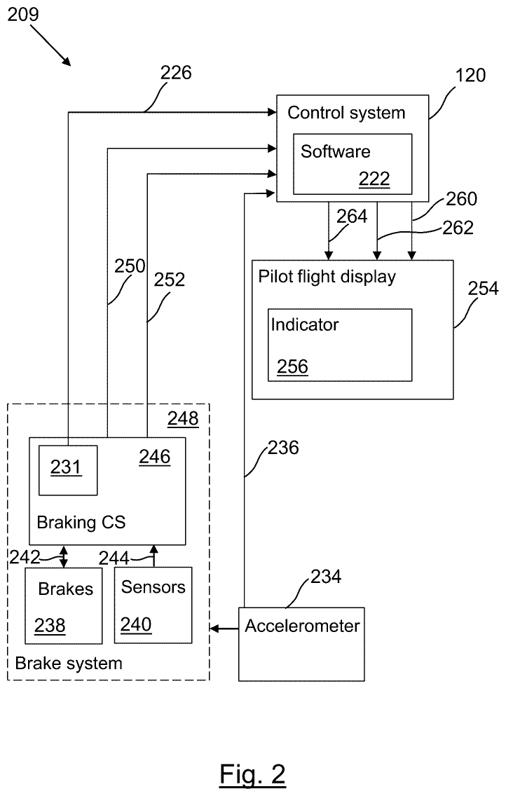

FIG. 1 shows a front view of an example aircraft 100 according to a first embodiment of the invention. The aircraft 100 comprises a control system 120 as described in relation to FIG. 2. The aircraft 100 is a commercial passenger aircraft. The aircraft 100 includes a cockpit 102. The aircraft 100 also includes two sets of main landing gear 104 each being in the form of two wheels on a common axle, each of the wheels being attached to a brake pack (not shown) which is controlled by a braking control system of the aircraft (referred to in FIG. 2). The aircraft 100 also includes nose landing gear 106. During ground maneuvers both the main landing gear 104 and the nose landing gear 106 are in contact with the ground 110. The aircraft 100 also includes ground spoilers located on the wings 105. The aircraft 100 also includes engines 107 which are fitted with reversers or reverse thrusters that can provide reverse thrust during braking. As noted above, the aircraft of the embodiment shown in FIGS. 1 and 2 includes a control system 120.

FIG. 2 schematically shows various systems 209 of the aircraft including the control system 120. The control system 120 is retrofitted by the installation of software 222 on an existing aircraft (but in other embodiments may be provided during the manufacture and assembly of the original aircraft). The brake system 248 includes a braking control system 246, brakes 238 which are associated with the main landing gear 104 (and also the nose landing gear 106), and sensors 240 which are located throughout the brake system 248. The braking control system 246 includes an autobrake system 231. The autobrake system 231 is configured to control the braking of the aircraft by the wheel brakes during landing automatically. The brake control system 246 also has the ability to control the use of the ground spoilers and reverse thrusters on engines 107. The autobrake system 231 can control the ground spoilers and reverse thrusters on engines 107 automatically during landing. The autobrake system 231 is configured to be able to set a target deceleration level for the aircraft during landing. The autobrake system 231 has two modes, a “brake-to-vacate” mode and a “classic” mode. If the autobrake system is in a “brake-to-vacate” mode, the target deceleration level will be set to allow the aircraft to exit the runway at a chosen location and at a desired speed. In “brake-to-vacate” mode the autobrake system can continuously vary the target deceleration level in order to achieve the chosen exit location and speed in an efficient manner. In “classic” mode, the autobrake system will control braking with the aim of meeting a set (and constant) target deceleration level. The pilot can choose this set target deceleration level or it can be determined by the autobrake system itself. The pilot can override the autobrake system 231 and can control the braking demand manually by operating the pedal brakes (not shown).

In use, the autobrake system 231 generates a target deceleration level 226, which is received by the control system.

In use, the braking control system 246 receives a measure of the rotation speed of the wheels of the aircraft from sensors 240 (as indicated by arrow 244), from which it can be determined that one or more of the aircraft wheels is skidding. This allows the braking control system 246 to determine that skid conditions are present. An example of a scenario where skid conditions are present is where there is ice on the runway, and this significantly reduces the friction between the landing gear wheels and the ground. If the friction between the landing gear wheels and the ground is unusually low, applying the brakes too much can lead to the wheels of the aircraft skidding over the ground, rather than rolling. This is undesirable, as it makes it difficult to decelerate the aircraft effectively, so systems are in place on the aircraft to limit the brakes from being applied too much when skid conditions are present, to facilitate controlled and efficient braking. The braking control system 246 is able to limit the aircraft's ability to brake using wheel brakes in order to avoid skidding when skid conditions are present during landing. In the present embodiment, the braking control system 246 outputs an indication 250 regarding whether the aircraft's ability to brake has been limited, which is received by the control system 120.

In use, the control system 120 receives an indication 236 of the deceleration of the aircraft from an accelerometer 234 on board the aircraft. The control system 120 compares the target deceleration level with the deceleration of the aircraft and determines whether the measured deceleration of the aircraft is below the target deceleration level.

In alternative embodiments, in use the control system 120 receives several indications 236 of the deceleration of the aircraft from multiple accelerometers located on board the aircraft. In use, the control system 120 determines an average deceleration of the aircraft based on the indications 236.

In alternative embodiments, the braking control system 246 determines whether the deceleration of the aircraft is below the target deceleration level, and outputs an indication to the control system 120 indicating whether the deceleration of the aircraft is below the target deceleration level, which is received by the control system 120.

In use, the braking control system 246 receives an indication of the braking pressure applied at the brakes of the wheels of the aircraft, an indication of whether ground spoilers are deployed and an indication of the status of the reverse thrusters, from which indications it can be determined that the aircraft is achieving maximum available braking. The braking control system 246 outputs an indication 252 of whether the aircraft is achieving maximum available braking, which is received by the control system 120. (In alternative embodiments the control system 120 receives directly a measure of the braking pressure applied at the brakes of the wheels of the aircraft, and receives indications of the status of the ground spoilers and reverse thrusters from which the control system determines whether or not the aircraft is achieving maximum available braking.)

In alternative embodiments, the braking control system 246 receives a measure of the braking pressure applied at the brakes of the wheels of the aircraft, and receives an indication of the position of the ground spoilers, from which it can be determined that the aircraft is achieving maximum available braking.

An example scenario in which the brake system 248 is providing “maximum available braking” but the aircraft deceleration is less than the target deceleration level, would be where the aircraft is carrying extra weight and therefore despite the aircraft brake system providing maximum braking, the target deceleration level cannot be achieved. The aircraft is only able to achieve “maximum available braking” in a scenario where there are no limitations placed on the amount of braking being demanded. This means that it is not possible for the aircraft to be achieving maximum available braking when the braking is limited due to skid conditions.

A primary flight display 254 is located in the cockpit 102 of the aircraft 100 and is visible to the pilot. The primary flight display 254 displays various information to the pilot (and/or other flight crew) under the control of the control system.

In use, when the control system 120 ascertains both that the deceleration of the aircraft is below the target deceleration and that aircraft's ability to brake has been limited (i.e. to implement skid control), the control system 120 outputs a command 260 to the primary flight display 254 to indicate to the pilot that the deceleration of the aircraft is below the target deceleration level due to the aircraft braking being limited. Upon receiving the command 260, the primary flight display 254 uses an indicator 256 to indicate to the pilot that skid conditions are causing the aircraft braking to be limited. The indicator 256 is a visual indicator.

In use, when the control system 120 ascertains that both the deceleration of the aircraft is below the target deceleration and “maximum available braking” is nevertheless being applied by the wheel brakes, the control system 120 outputs a command 262 to the primary flight display 254 to indicate to the pilot that the deceleration of the aircraft 100 is below the target deceleration level and the aircraft is nevertheless achieving maximum available deceleration. Upon receiving the command 262, the primary flight display 254 uses the indicator 256 to indicate to the pilot that although the target deceleration level is not being met, the aircraft is achieving maximum available braking.

In use, when the control system 120 ascertains that the deceleration of the aircraft is in accordance with the target deceleration (i.e. the target deceleration is being met), the control system 120 outputs a command 264 to the primary flight display 254 to indicate to the pilot that the deceleration of the aircraft 100 is meeting the target deceleration level. Upon receiving the command 264, the primary flight display 254 uses the indicator 256 to indicate to the pilot that the target deceleration level is being met

During landing of the aircraft, when the aircraft deceleration is not meeting the target deceleration level, the pilot may feel that the aircraft is not decelerating as much as expected and may see on a cockpit instrument that the decrease in speed of the aircraft is lower than expected. This feeling of reduced deceleration could lead the pilot to perform a pedal take-over which significantly increases pilot workload during landing. However, according to this embodiment, the primary flight display 254 will indicate to the pilot that the aircraft braking is limited due to skid conditions or that maximum braking is being applied. For example, the pilot will see that the indicator 256 on the primary flight display is emitting a green light indicating that the aircraft braking is limited due to skid conditions. This reassures the pilot that the brake system of the aircraft is working correctly and there is not a fault with the brake system causing unexpectedly low deceleration. The pilot does not have to consider overriding the autobrake system of the aircraft, or triggering an emergency brake system, as they can be assured that although deceleration is lower than desired, it is due to the brake system of the aircraft working correctly. It will also be appreciated that in a scenario where aircraft braking is skid-limited, or where the aircraft is already achieving maximum available braking, performing a pedal take over may not necessarily result in increased deceleration of the aircraft, as aircraft deceleration is likely to already be at a maximum achievable level.

In another example scenario, the aircraft may be carrying extra weight (and therefore “overweight” but still within operational limits of course). Therefore despite full pressure being applied on all brakes and the use of ground spoilers and/or reverse thrusters, the aircraft deceleration is lower than the target deceleration level. The pilot feels the reduced deceleration and sees on a cockpit instrument that the aircraft speed is not reducing as much as expected. The pilot sees that the indicator 256 on the primary flight display is emitting a blue light, indicating that the aircraft is achieving maximum available braking. This reassures the pilot that they do not need to take action to override the autobrake system by performing a pedal take-over. As described above, the workload of the pilot is reduced, and the autobrake system can continue to control the deceleration of the aircraft. This reduces the potential for pilot error during landing and reduces the workload of the pilot in these scenarios.

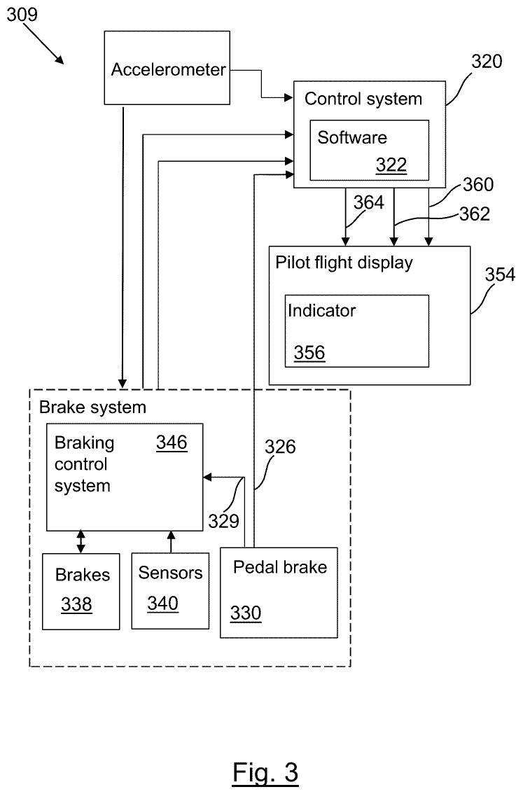

FIG. 3 schematically shows various systems 309 of the aircraft including a control system 320 according to a similar but alternative embodiment to that shown in FIG. 2. The control system 320 is retrofitted by the installation of software 322 on an existing aircraft. The pilot can manually set a target deceleration level using a pedal brake 330. In use, the braking control system 346 receives an indication 329 of the target deceleration level from the pedal brake 330. The pedal brake 330 being manually operable by the pilot. The control system 320 receives an indication 326 of the target deceleration level from the pedal brake 330. The pedal brake 330 is operable by the pilot throughout landing and therefore the target deceleration level is able to be varied throughout landing. The control system 320 receives periodic indications 326 of the target deceleration level and upon receiving the target deceleration level determines whether the measured deceleration of the aircraft is below the target deceleration level. The control system 320 periodically output commands (360, 362, 364) to the primary flight display 354 to indicate to the pilot whether the deceleration of the aircraft is below or equal to the target deceleration level, and (in the case where the deceleration of the aircraft is below the target deceleration level) whether this is due to the deceleration of the aircraft being limited or whether it is despite the aircraft 100 achieving maximum available braking. The brakes 338 and sensors 340 are similar to the corresponding brakes 238 and sensors 240 of the embodiment shown by FIG. 2.

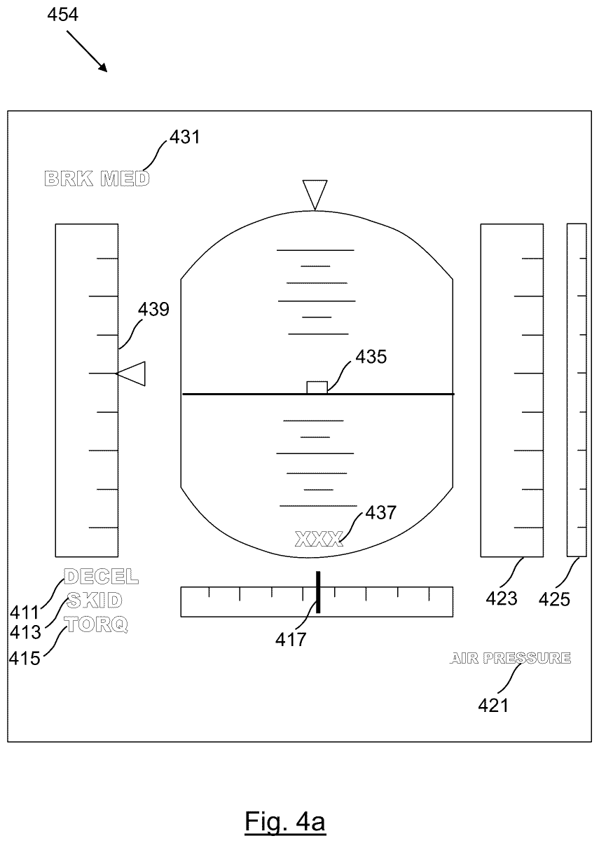

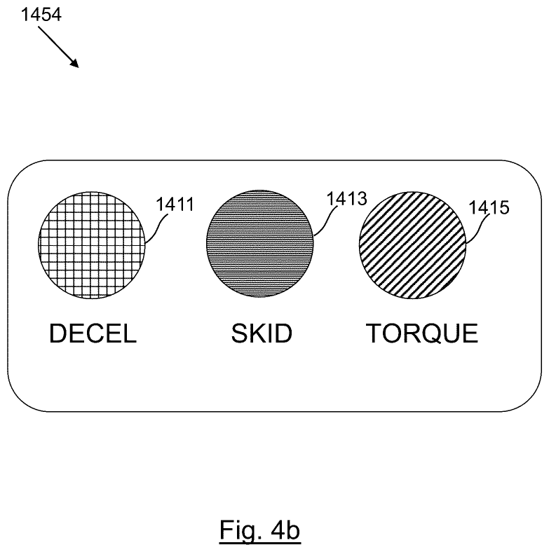

FIG. 4a shows a schematic diagram of a primary flight display 454. The primary flight display 454 is located in the cockpit of an aircraft and is positioned so as to be visible to the pilot. The primary flight display has a first indicator 411 to indicate to the pilot whether the deceleration of the aircraft is meeting the target deceleration level. The first indicator 411 is displayed on the primary flight display 454 as light-up text “DECEL”. In use, when the first indicator 411 lights up, this indicates to the pilot that the aircraft deceleration is meeting the target deceleration level. The primary flight display 454 has a second indicator 413 to indicate to the pilot whether the deceleration is lower than the target deceleration level due the aircraft braking being limited due to skid conditions. The second indicator 413 is displayed on the primary flight display 454 as light-up text “SKID”. In use, when the second indicator 413 lights up, this indicates to the pilot that the deceleration of the aircraft is lower than the target deceleration level due the aircraft braking being limited due to skid conditions. The primary flight display 454 has a third indicator 415 to indicate to the pilot that the deceleration of the aircraft is less than the target deceleration level despite the aircraft achieving maximum available braking. The third indicator 415 is displayed on the primary flight display 454 as light-up text “TORQ”. In use, when the third indicator 415 lights up this indicates to the pilot that the deceleration is lower than the target deceleration level despite the aircraft achieving maximum braking. In embodiments, this indicates to the pilot that full pressure is being applied on all brakes. In alternative embodiments, this indicates to the pilot that full pressure is being applied on all brakes, and ground spoilers are deployed and reverse thrusters are in use.

The primary flight display 454 is one of several displays in the cockpit and displays various information, some of which will now be mentioned. The primary flight display 454 has an air pressure indicator 421. The primary flight display 454 has a vertical speed indicator 425. The primary flight display 454 has a heading indicator 417. The primary flight display 454 has an aircraft nose attitude indicator 435. The primary flight display 454 has an indicator 431 to show what mode the autobrake system is in. In this example, “BRK MED” indicates that the classic autobrake mode is active. The primary flight display 454 has a radio altitude indicator 437. The primary flight display 454 has an altitude indicator 423. The primary flight display has an airspeed indicator 439. The primary flight display 454 also has (not shown) an indicator of slat/flap positions, a landing gear position indicator, pitch trim indications, and a ground spoiler position indicator.

In an alternative embodiment, FIG. 4b shows a portion 1454 of a primary flight display that includes three lights. The first light 1411 indicates when illuminated that the aircraft deceleration is equal to the target deceleration level. The second light 1413 indicates when illuminated that the aircraft deceleration is below the target deceleration level due to the aircraft braking being limited due to skid conditions. The third light 1415 indicates when illuminated that the aircraft deceleration is below the target deceleration level despite full brake pressure being applied on all brakes, in this scenario the aircraft is achieving maximum available braking.

In alternative embodiments, the primary flight display may have a first indicator that in a first state (e.g. green light or text) indicates to the pilot that the deceleration of the aircraft is meeting the target deceleration level and in a second state (e.g. an amber or orange light or text) indicates to the pilot that the deceleration of the aircraft is not meeting (i.e. is below) the target deceleration level, but because the aircraft braking is limited (e.g. skid conditions) or the aircraft is achieving maximum available braking (e.g. maximum brake pressure is being provided) and therefore deceleration of the aircraft cannot be increased. It may be that the first indicator does not, by itself, inform the pilot as to which of the two reasons (aircraft braking is limited and aircraft achieving maximum available braking) apply.

In alternative embodiments, the primary flight display may have a first indicator that, when illuminated, indicates to the pilot that the deceleration of the aircraft is meeting the target deceleration level and a second indicator (being distinct from the first indicator) that, when illuminated, indicates to the pilot that the deceleration of the aircraft is not meeting (i.e. is below) the target deceleration level because either the aircraft braking is limited (e.g. skid conditions) or the aircraft is achieving maximum available braking (e.g. maximum brake pressure is being provided) and therefore deceleration of the aircraft cannot be increased. Again, it may be that the second indicator does not, by itself, inform the pilot as to which of the two reasons (aircraft braking is limited and aircraft achieving maximum available braking) apply.

There may be an indicator that is configured to indicate by emitting a first color of light, that the deceleration of the aircraft is meeting the target deceleration level, to indicate by emitting a second different color of light, that the deceleration of the aircraft is less than the target deceleration level due to the aircraft braking being limited due to skid conditions, and by emitting a third different color of light, that the deceleration of the aircraft is less than the target deceleration level despite the aircraft achieving maximum available braking.

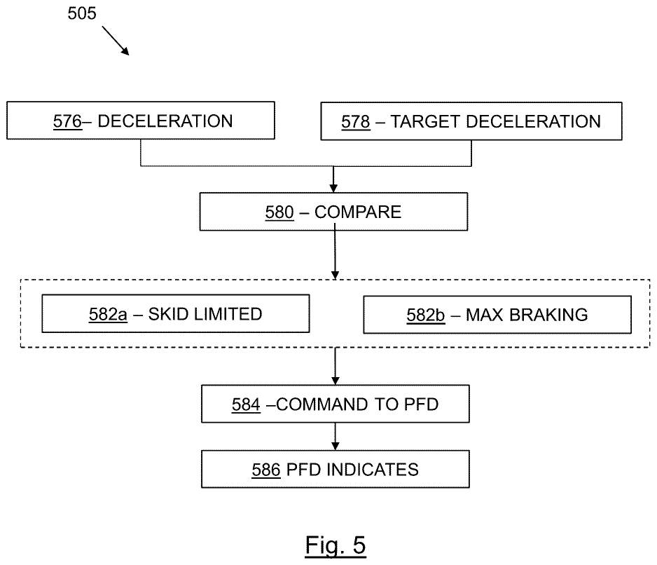

FIG. 5 shows a flow diagram 505 showing an example method of using the control system according to the first embodiment. The method includes a step 576 of the control system receiving an indication of the deceleration of the aircraft from an accelerometer. As step 578 (which may occur in parallel or at a different time) the control system receives an indication of the target deceleration level of the aircraft. In step 580, the control system compares the target deceleration level with the measured deceleration of the aircraft (as measured by an accelerometer). At step 582a, the control system receives an indication of whether the aircraft braking is limited due to skid conditions (which may be a step that is only performed in such circumstances). At step 582b of the control system receives an indication of whether the aircraft is achieving maximum available braking (which may be a step that is only performed in such circumstances). The control system outputs a command (step 584) to the primary flight display to indicate to the pilot one of the following: a) that the target deceleration level is being met (e.g. equal to the measured deceleration), b) that the measured deceleration is less than the target deceleration level and that this is due to the aircraft braking being limited due to skid conditions, c) that the measured deceleration is less than the target deceleration level but that the aircraft is achieving maximum available braking, and—optionally—d) that the measured deceleration is less than the target deceleration level but maximum available braking is not being achieved, and the braking is not being limited due to skid conditions (which may be indicative of a fault state). In step 586, the primary flight display indicates to the pilot using a visual indicator which of situations a), b), c) and d) apply.

In certain embodiments, or use cases, the step of the control system receiving an indication of the target deceleration level of the aircraft may involve the control system receiving the indication of the target deceleration level from an autobrake system of the aircraft. In certain embodiments, or use cases, the step of the control system receiving an indication of the target deceleration level of the aircraft, may involve the control system receiving the indication of the target deceleration level from a pedal brake manually operated by the pilot.

In certain embodiments, the step of the control system receiving an indication of whether the aircraft braking is limited due to skid conditions, may include the control system receiving an indication that the aircraft braking is not limited due to skid conditions. In certain embodiments, the step of the control system receiving an indication of whether the aircraft is achieving maximum available braking, may include the control system receiving an indication that the aircraft is not achieving maximum available braking. If the aircraft deceleration is not equal to the deceleration target level and the aircraft braking is not limited nor is the aircraft achieving maximum available braking (i.e. situation (d) above), then in step 586, the primary flight display indicates that information to the pilot using a visual indicator.

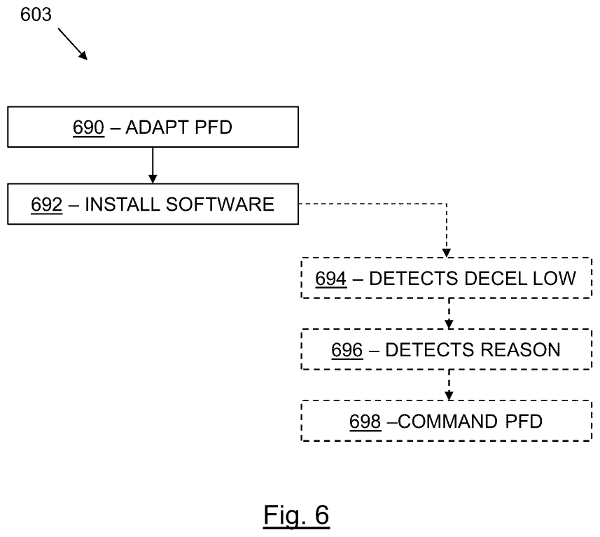

FIG. 6 shows a flow diagram 603 showing an example method of modifying an existing aircraft. The pre-existing systems on the aircraft already include a braking control system that includes an autobrake system. The existing aircraft includes a primary flight display with a primary indicator for indicating whether the deceleration of the aircraft is equal to a target deceleration level. The method comprises a step 690 of adapting the primary flight display on the existing aircraft to have a secondary indicator. The secondary indicator being configured to indicate to the pilot the reason why the deceleration of the aircraft cannot be increased despite being less than the target deceleration level. The secondary indicator is a visual indicator that is visible to the pilot within the cockpit.

The method comprising a step 692 of installing a software on a system of the aircraft such that when installed, the system of the aircraft is configured to: take a step 694 of detecting that the deceleration of the aircraft is less than a target deceleration level, take a step 696 of detecting whether this is due to the aircraft braking being limited due to skid conditions or whether this is despite the aircraft achieving maximum available braking, and to take a step 698 of issuing a command to the primary flight display to indicate to the pilot with the reason why deceleration of the aircraft is less than the target deceleration.

In certain embodiments, the step of adapting the primary flight display on the existing aircraft involves adapting a display, or other part of the cockpit, so that it can be used to indicate to the pilot the reason why the deceleration of the aircraft cannot be increased despite being less than the target deceleration. For example, there may be a step of adapting an existing indicator, or providing a new indicator, so that when it emits light of a first color, this indicates to the pilot that the deceleration of the aircraft is equal to the target deceleration level; when it emits light of a second color, this indicates to the pilot that the deceleration of the aircraft is less than the target deceleration level due to the aircraft braking being limited; and when it emits light of a third color, this indicates to the pilot that the deceleration of the aircraft is less than the target deceleration level despite the aircraft achieving maximum available braking (the first color being different from the second color, and the third color being different from both the first color and the second color).

In certain embodiments, the step of adapting the primary flight display on the existing aircraft involves adding two additional indicators to the primary flight display. The first of these additional indicators is configured to indicate to the pilot that the deceleration of the aircraft is less than the target deceleration level due to the aircraft braking being limited and the second of these additional indicators being configured to indicate to the pilot that the deceleration of the aircraft is less than the target deceleration level despite the aircraft achieving maximum available braking.

In certain embodiments of the invention, there is a computer program product (for example as shown by the software 222 in FIG. 2). The computer program product comprises instructions which, when the program is executed by a computer system (for example the control system 120 of FIG. 2) of an aircraft, allow the aircraft to carry out the method as described in relation to FIG. 5. The implementation of the computer program product on an aircraft system causes an interaction between a brake system, a control system and a pilot indication system of the aircraft, such that the control system is able to receive inputs from the brake system of the aircraft and is able to issue commands to the pilot indication system to indicate to the pilot whether the deceleration of the aircraft is below a target deceleration level, and if so, what the reason for the lower deceleration is.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In alternative embodiments, the primary flight display has a single indicator to provide a first indication to the pilot to indicate that the deceleration of the aircraft is meeting the target deceleration level. The same indicator provides a second indication to the pilot to indicate to the pilot that the deceleration of the aircraft is less than the target deceleration level due to the aircraft braking being limited. The same indicator provides a third indication to indicate to the pilot that the deceleration of the aircraft is less than the target deceleration level despite the aircraft achieving maximum available braking. Thus, the first indication, the second indication and the third indication are all provided by the same indicator. The first indication may be distinguished from the second indication and the third indication in that a different color light is provided by the indicator. The second and third indications are distinguished from each other in the same way. The color of the indicator can change throughout the landing process, allowing the pilot to have detailed knowledge of the deceleration of the aircraft and how the deceleration compares to the target deceleration level throughout the landing and deceleration process.

In alternative embodiments, the first indication is a lack of a light provided by the indicator (i.e. an indicator light turning off can indicate to the pilot that the deceleration of the aircraft is equal to the target deceleration level). In alternative embodiments, the second indication and the third indication are both a lack of an indicator light being displayed on the primary flight display. An indicator light that is OFF on the primary flight display can indicate to the pilot that the aircraft is achieving maximum available braking or that the aircraft braking is limited due to skid conditions.

In alternative embodiments, an indicator light that is ON and is emitting yellow light on the primary flight display indicates to the pilot that the aircraft deceleration is meeting the target deceleration level. The indicator light changing color to emit green light can indicate to the pilot that the aircraft is not meeting the target deceleration level due to the aircraft braking being limited by skid conditions. The indicator light changing color to emit blue light can indicate to the pilot that the aircraft is not meeting the target deceleration level despite the aircraft achieving maximum available braking. The indicator light turning off can indicate to the pilot that the aircraft is not meeting the target deceleration level, but the aircraft is not achieving maximum available braking and there is no limitation on the braking of the aircraft. Other color combinations and off/on states could be used to indicate the various different scenarios.

In alternative embodiments, the control system is configured to output a command to the primary flight display to indicate to the pilot that the deceleration of the aircraft is below the target deceleration level, but the aircraft is not achieving maximum available deceleration and there is no limitation on the braking of the aircraft.

In other embodiments, some of the information displayed to the pilot in the event that deceleration if below the target deceleration may be displayed via other displays in the cockpit for example via an airport navigation display, that also displays groundspeed.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

The term ‘or’ shall be interpreted as ‘and/or’ unless the context requires otherwise.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority. Claimed is:

1. A control system for an aircraft, the aircraft having a brake system that is configured to issue a command for a target deceleration level during landing and to limit the braking of the aircraft based on skid conditions being detected, the control system being configured:
to receive, as a first input, an indication from the brake system when an ability of the aircraft to brake is limited;
to receive, as a second input, an indication from the brake system when the aircraft is achieving a maximum available braking;
to receive, as a third input, an indication of a deceleration of the aircraft;
to receive, as a fourth input, an indication of a target deceleration level from the brake system;
to generate based on the first input, the second input, the third input, and the fourth input:
a first output for causing an indication that alerts a pilot to a first scenario in which the deceleration of the aircraft is below the target deceleration level due to the aircraft braking being limited; and
a second output for causing an indication that alerts the pilot to a second scenario in which the deceleration of the aircraft is below the target deceleration level despite the aircraft achieving maximum available braking.

2. The control system according to claim 1, wherein the control system is further configured to receive the indication of the deceleration of the aircraft from one or more accelerometers located on the aircraft.

3. The control system according to claim 1, wherein the target deceleration level is variable.

4. The control system according to claim 1, wherein the brake system of the aircraft includes a pedal brake, and the control system is further configured to receive the indication of the target deceleration level from the pedal brake.

5. The control system according to claim 1, wherein the brake system of the aircraft includes an autobrake system, and the control system is further configured to receive the indication of the target deceleration level from the autobrake system.

6. The control system according to claim 1, wherein the control system is configured to output a command to a display unit to visually indicate to the pilot that deceleration of the aircraft is below the target deceleration level.

7. The control system according to claim 1, wherein the control system is further configured to output a command to a display unit to indicate with a first indication that the ability to brake is limited due to skid conditions when the aircraft is in a skid limited state,
wherein the control system is configured to output a command to the display unit to indicate with a second indication that the aircraft is achieving maximum available braking, when the aircraft is achieving maximum available braking but is not able to achieve the target deceleration level, the second indication different from the first indication.

8. An aircraft comprising:
a brake system;
a display unit;
and the control system according to claim 1, wherein the control system is configured to display on the display unit the indication that alerts the pilot to the first scenario and the indication that alerts the pilot to the second scenario.

9. The aircraft according to claim 8, wherein the brake system of the aircraft is configured to determine whether the aircraft is experiencing skid conditions by analyzing inputs from sensors on one or more wheels of landing gear of the aircraft, and
wherein the brake system is configured to limit the braking of the aircraft when the brake system determines a presence of skid conditions.

10. The aircraft according to claim 8, wherein the display unit includes a visual indicator to provide a visual indication to the pilot that deceleration of the aircraft is below the target deceleration level either due to the aircraft braking being limited due to skid conditions or despite the aircraft achieving maximum available braking.

11. The aircraft according to claim 10, wherein the visual indication that the aircraft braking is limited due to skid conditions, is different from the visual indication that the aircraft is achieving maximum available braking.

12. The aircraft according to claim 8, wherein the brake system of the aircraft is configured to automatically determine the target deceleration level.

13. The aircraft according to claim 8, wherein the brake system of the aircraft includes a pedal brake configured to be operated manually to allow a pilot to determine the target deceleration level.

14. A method of braking an aircraft during landing, the method comprising:
comparing, with the use of a control system, a measured deceleration of the aircraft with a target deceleration level, and
the control system outputting a command to a cockpit instrument to indicate to a pilot why the measured deceleration of the aircraft is below the target deceleration level.

15. The method according to claim 14, wherein the method further comprises:
the control system receiving an indication regarding an ability of the aircraft to brake being limited due to skid conditions, and
wherein the outputting the command includes outputting a command to indicate to the pilot that a braking of the aircraft is limited due to skid conditions.

16. The method according to claim 14, wherein the method further comprises:
receiving, by the control system, an indication regarding whether the aircraft is achieving maximum available braking, and
wherein the outputting the command includes outputting a command to indicate to the pilot that the aircraft is achieving maximum available braking.

17. A non-transitory computer readable medium storing a computer program comprising instructions which, when the computer program is executed by a processor of a system cause the system perform the method of claim 14.

18. The non-transitory computer readable medium according to claim 17, wherein the computer program causes an interaction between a brake system, the control system and a pilot indication system, the brake system, the control system and the pilot indication system being at least in part implemented by one or more on-board computers, the control system being configured to receive inputs from the brake system, and as a result to output signals that control or influence indications provided to the pilot by the pilot indication system.

19. A method of modifying an existing aircraft, the aircraft having a primary indication on a cockpit display for indicating whether a deceleration of the aircraft is equal to a target deceleration level, the method comprising:
adapting the cockpit display to have a secondary indication, the secondary indication indicating a reason why deceleration of the aircraft cannot be increased despite deceleration being below a target deceleration level;
installing a software on a system of the aircraft such that when installed the system of the aircraft is configured to:
detect whether the deceleration of the aircraft is less than the target deceleration level;
detect whether this is due to the aircraft braking being skid limited or despite the aircraft achieving maximum available braking; and
issue a command to the cockpit display to indicate to a pilot using the secondary indication, why deceleration of the aircraft cannot be increased despite deceleration being below the target deceleration level.

20. A display apparatus, the display apparatus comprising:
a display unit for an aircraft cockpit; and
a control system configured to perform the method of claim 14,
the display unit configured to indicate to the pilot with a first indication when a deceleration is below the target deceleration level due to the aircraft braking being limited due to skid conditions, and to indicate to the pilot with a second indication when the deceleration is below the target deceleration level despite the aircraft achieving a maximum available braking.
